(19) United States
(12) Patent Application Publication
(10) Pub. No.: US 2018/0021944 A1
(43) Pub. Date: Jan. 25, 2018

(54) MANIPULATOR SYSTEM FOR THE COORDINATED CONTROL OF AT LEAST TWO MANIPULATORS

(71) Applicant: KUKA Roboter GmbH, Augsburg (DE)

(72) Inventor: Günter SCHREIBER, Friedberg (DE)

(21) Appl. No.: 15/547,157

(22) PCT Filed: Jan. 29, 2016
(86) PCT No.: PCT/EP2016/051910

§ 371 Date: Jul. 28, 2017

(30) Foreign Application Priority Data
Feb. 5, 2015 (DE) 10 2015 202 017.7

(51) Int. Cl. B25J 9/00; G05B 19/418; B25J 9/16

(52) U.S. Cl. CPC B25J 9/0084; B25J 9/1682; G05B 19/418

(57) ABSTRACT

A manipulator system for the coordinated control of at least two manipulators. The system includes a main computer that is configured for carrying out a sequence control, and at least two multiaxial manipulators. A manipulator controller and at least one axis controller are associated with each manipulator. The manipulator controllers are spatially separate from the main computer and set up in their own housings. Each manipulator preferably includes converters for controlling the actuators of the axes of the manipulator, wherein the converter associated with an actuator is situated in the vicinity of the actuator in such a way that the converter can be moved along with a movement of the associated manipulator.

### 1. FIELD OF THE INVENTION

The invention relates to a manipulator system for the coordinated control of at least two manipulators. The coordinated control of at least two manipulators is used in applications in which multiple manipulators are to cooperate in order to jointly perform tasks, for example in industrial production lines.

### 2. BACKGROUND

In robotics, a manipulator is understood to mean a device that allows physical interaction with the surroundings. According to EN ISO 8373, industrial robots are automatically guided multipurpose manipulators that are equipped with three or more freely programmable movement axes and used in either stationary or mobile industrial applications. Manipulators guide grippers, tools (end effectors), or workpieces and the like.

Movement axes (axes) are guided, independently driven members. In manipulators, these axes are used to generate defined movements for positioning and orienting objects. The members of the manipulator are driven by means of actuators, which are usually electric motors.

The defined movements for positioning and orienting the manipulator are customarily planned by a user. The path movement of the manipulator planned in this way typically includes a given trajectory (path of motion), which is defined via points in space as well as path speeds and path accelerations. The planned path movement of the manipulator is provided to a manipulator control device, associated with the manipulator, by means of a sequence control. In the manipulator control device associated with the manipulator, the sequence control is converted into commands for controlling the manipulator. Known manipulator control devices include a manipulator controller and at least one axis controller. The manipulator controller converts the sequence control, and thus the planned path movement of the manipulator, into control commands for an axis controller. These control commands typically include information concerning the preferred rotation angles, speeds, and accelerations of the individual axes of the manipulator in order to achieve the planned path movement, including the trajectory, path speed, and path acceleration of the manipulator.

The control commands sent to the axis controller for controlling the axes are converted into converter commands by the axis controller. The converter commands contain a setpoint motor torque, a setpoint motor speed, and/or a setpoint motor current for each axis, corresponding to the planned path movement. The converter commands to the axis controller are converted in the converter associated with the actuator in such a way that the energy provided to the actuator, which is present in the form of an alternating current or a direct current, is converted into an alternating current with a variable amplitude and/or frequency. The actuators are typically three-phase electric machines, so that the provided energy is converted into a variable three-phase alternating current. Alternating current-based converters are also common. The speed and/or acceleration as well as the rotational direction of the actuator, and thus the planned path movement of the manipulator, may be implemented by adapting the amplitude and/or frequency.

Conventional manipulator control devices include the above-described components such as a sequence control, manipulator controller, axis controller, and converter, and are integrated into a single control cabinet. This is advantageous due to the fact that the components are easier to cool, and the communication between the individual components may be achieved with an internal bus layout. In such applications, the variable alternating current generated by the converters is provided to the actuators via power-conducting lines, so that the manipulator itself is connected to the manipulator control device. It is usually necessary to cover long distances from the control cabinet to the manipulator, which may cause losses in the power-conducting lines and result in a high level of cabling effort.

For the coordinated operation of multiple manipulators in an application, the manipulator controllers, the axis controllers, and the converters of all manipulators are typically commanded by a central sequence control and installed in a single control cabinet. The internal bus layout may thus also be used for coordinating the path movements of the manipulators. This results in a central multi-manipulator control device in which the control of the entire system takes place. However, it is difficult to expand such systems, which is an important requirement in industrial applications. The user is therefore forced to replace the multi-manipulator control device when an additional manipulator is to be integrated into the system. Alternatively, appropriate excess capacity must be held ready to allow additional manipulators to be integrated into the application, which incurs high costs.

### 3. DETAILED DESCRIPTION OF THE INVENTION

The object of the manipulator system according to the invention is to eliminate or at least reduce the stated disadvantages. The object is achieved by a manipulator system according to the independent claims.

In particular, the objects are achieved by a manipulator system for the coordinated control of at least two manipulators, comprising: a main computer that is configured for carrying out a sequence control, at least two multiaxial manipulators, wherein a manipulator controller is associated with each manipulator, the manipulator controllers being spatially separate from the main computer and in each case set up in their own housing, and wherein each manipulator includes converters for controlling the actuators of the axes of the manipulator, wherein the converter associated with an actuator is situated in the vicinity of the actuator in such a way that the converter can be moved along with a movement of the manipulator.

The spatial separation of the main computer and the manipulator controllers allows possible expansions of the manipulator system, i.e., flexibly providing additional manipulators into the manipulator system for the integration, without having to already know the final number of manipulators when the main computer is first set up. The manipulator controllers are preferably connected to the main computer via a bus connection. The cabling effort in the installation of the manipulator system may be greatly reduced in this way. Likewise, the dimensions of the control cabinet of the main computer may be reduced considerably by relocating the manipulator controllers.

Furthermore, due to the spatial separation of the main computer and the manipulator controllers, it is possible to set up the manipulator controllers in the immediate vicinity of the associated manipulators. Consequently, the signal paths from the manipulator controllers to the converters may be kept short. In particular when analog signals are used, protection from interferences is also increased, so that higher reliability of the manipulator system may be achieved.

The preferred use of bus connections between the main computer and the manipulator controllers allows utilization of error protocols. Therefore, bus connections are also well suited for fairly long transmission paths of the signals.

Due to situating the converters in the vicinity of an actuator in such a way that the converter can be moved along with a movement of the manipulator, the power-conducting lines from the converter to the actuator may be considerably shortened. This results in a significant reduction in line losses. In addition, it is possible to provide the manipulator itself with only one power-conducting line, which is not split until in the manipulator in order to supply the individual converters with power. In previously known approaches, in which the converters are integrated into the control cabinet, it is absolutely necessary to supply each actuator with its own power-conducting line.

The converter associated with an actuator is preferably situated in a manipulator arm. The converters are protected from environmental influences by situating the converters in the manipulator arm itself. This is particularly advantageous when the manipulators are to be used in a dusty or humid environment.

At least one axis controller is preferably associated with each manipulator of the manipulator system, wherein the at least one axis controller (i.e., the hardware) is preferably situated on the manipulator in such a way that the at least one axis controller can be moved along with a movement of the manipulator.

Situating the axis controllers (i.e., the hardware) on the manipulator is particularly advantageous, since the control of the actuators or the converters for the actuators usually takes place in the axis controller. The signals returned by the actuators may thus be led over very short signal paths for the control, so that the cabling effort may be reduced, and possible interferences in the signal line may be reduced or avoided.

The at least two axis controllers are preferably associated with the main computer in a chain topology or in a star topology.

In the star topology, all manipulator controllers are directly connected to the main computer. The star topology allows high transmission rates, which is particularly advantageous for complex path movements of the manipulators that are to be coordinated. In addition, the star topology is easily expandable, and maintenance is easy due to the simple design. Moreover, in the event of a failure of one manipulator controller, the remaining manipulator system can continue operation without further limitations.

In the chain topology, a first manipulator controller is connected to the main computer via a bus connection, for example. The additional manipulator controllers are now connected in each case to their predecessors (series connection). The signal to and from a manipulator controller passes through its predecessor and to the main computer. Priorities must be assigned in this topology. It is thus specified that information can be transmitted, for example, only when the line is free. Moreover, it may be specified that some manipulator controllers have absolute priority over others. Conflicts and malfunctions may thus be prevented, or commands with special priority, for example safety-relevant commands, may be carried out immediately.

The sequence control preferably includes planned path movements of the at least two manipulators, and the main computer includes a command switch that is configured for coordinating planned path movements of the at least two manipulators.

The coordination of the planned path movements of the at least two manipulators may take place in a predetermined manner, for example over a specified time sequence of individual movements of the manipulators in question. Likewise, movement conditions may also influence the coordination of the planned path movement of the at least two manipulators in a predetermined manner. Such movement conditions preferably include position conditions, orientation conditions, speed conditions, and/or acceleration conditions.

For example, a first manipulator may be allowed to continue its planned path movement only after a movement condition of a second manipulator has been met. This movement condition may include, for example, that the end effector of the manipulator has come to a stop at a certain position and in a certain orientation.

Coordinating the planned path movement of the at least two manipulators is particularly advantageous in applications in which a manipulator guides a workpiece, and a second manipulator machines the workpiece guided by the first manipulator. This allows very flexible machining steps. For example, if a welding line runs around a workpiece during welding, and an individual manipulator cannot completely travel over this welding line without having to set it down, it is possible to position or orient the workpiece during the welding, using a second manipulator, in such a way that the first manipulator, which is the welding manipulator, is able to weld the welding line without setting the workpiece down.

The coordination effort may be reduced by integrating the planned path movements of the at least two manipulators into a sequence control that runs on the computer, since it is not necessary to balance multiple sequence controls. In addition, coordinating the planned path movements on the hierarchical system level of the manipulator controllers allows the control of the movement of the manipulators in the particular manipulator controllers, and the control of the individual axes of the manipulator in the axis controllers, to be carried out and thus to be separate from the sequence control. The required computing capacity of the system may be reduced in this way.

The main computer is preferably configured for sending commands of the sequence control to the manipulator controllers, and the particular manipulator controller is configured for sending commands for controlling the axes of the manipulator to the at least one axis controller, and the axis controller is preferably configured for converting commands for controlling the axes into converter commands.

This arrangement is advantageous, since the particular manipulator controller is able to convert the commands of the sequence control that are assigned to it. The conversion of the commands of the sequence control thus takes place separately on a dedicated system level. In addition, any controls of the movement of the manipulator associated with the manipulator controller may thus take place separately on a dedicated system level. This arrangement is also advantageous due to the fact that the axis controller can generate the converter commands on a lower hierarchical system level. The correct conversion of the converter commands may also be monitored on this system level, and the control of the converters may take place on this system level. As a result, fewer signals have to be exchanged by the arrangement, thus achieving a high level of robustness of the system.

The objects of the invention are preferably further achieved by a manipulator system for the coordinated control of at least two manipulators, comprising a main control device that is associated with a first of the at least two manipulators and that is configured for carrying out a sequence control, wherein the main control device includes a command switch and a manipulator controller, and the command switch is configured for sending commands of the sequence control to the manipulator controller, and the manipulator controller is configured for sending commands for controlling the axes of the first manipulator to the axis controller, and the axis controller is configured for converting commands for controlling the axes into converter commands, and comprising at least one secondary control device which is associated with the second of the at least two manipulators and which has at least one secondary control device that is spatially separate from the main control device, is set up in its own housing, and has an independent power supply, wherein the at least one secondary control device includes a manipulator controller, and the command switch of the main control device is configured for sending commands of the sequence control to the (second) manipulator controller, and the (second) manipulator controller is configured for sending commands for controlling the axes of the second manipulator to the axis controller of the second manipulator, and the axis controller is configured for converting commands for controlling the axes into converter commands.

By using a main control device in the manipulator system, it is possible to carry out the coordinated control of at least two manipulators without a main computer and without a central multi-manipulator control device. A manipulator control device having sufficient computing power for coordinating the planned movements of the manipulators is preferably used as the main control device. Thus, no additional hardware components are necessary in the manipulator system for coordinating the planned movements of the manipulators.

The hardware configuration of the at least one secondary control device may preferably correspond to the main control device. The distinction between the main control device and the secondary control device thus results from the software configuration of the control devices. Although the main control device includes a sequence control and a command switch, these components are not implemented (in software) on the secondary control device. This allows the use of structurally identical control devices that may be used as a secondary or main control device, and allows a reduction in costs due to a small number of variants.

The spatial separation of the main control device and the secondary control device allows the manipulator system to be made flexible for possible expansions. The secondary control device is preferably connected to the main control device via a bus connection. The cabling effort in the installation of the manipulator system may thus be significantly reduced. An independent power supply for the main control device and an independent power supply for the secondary control device allow the main control device and/or the secondary control device to be situated in practically any spatial arrangement in the manipulator system.

Furthermore, the main control device and/or the secondary control device may be set up in the immediate vicinity of the associated manipulators due to the spatial separation of the main control device and the secondary control device. The signal paths from the main control device and/or the secondary control device to the manipulators may thus be kept short. In addition, the power-conducting lines from the converters of the main control device and/or the secondary control device to the actuators of the manipulators may be kept correspondingly short, resulting in a reduction in line losses.

The preferred use of a bus connection between the main control device and the secondary control device allows the utilization of error protocols. The bus connection is therefore also optimally suited for fairly long transmission paths of the signals.

By setting up the command switch in the main control device in such a way that the commands of the sequence control for controlling the first manipulator may be sent to the manipulator controller of the first manipulator, and commands of the sequence control for controlling the second manipulator may be sent to the manipulator controller of the second manipulator, the coordination of the planned path movements of the at least two manipulators may take place in the command switch of the main control device. The control and monitoring of the movement the manipulators preferably takes place in the manipulator controllers, and particularly preferably in the axis controllers.

This arrangement is advantageous due to the fact that the manipulator controllers and the axis controllers carry out the control and monitoring of the movement of the manipulators on a lower hierarchical system level. Therefore, it is not necessary to send signals for controlling the movement of the manipulators or for controlling the axes for the sequence control, thereby achieving a high level of robustness of the system.

The manipulator system preferably includes a third manipulator having a third secondary control device, and the secondary control devices are associated with the main control device, preferably in a chain topology or in a star topology.

As described above, the star topology allows high transmission rates, and in addition to other advantages is also easily expandable. The chain topology, as described above, for example allows simple prioritization of individual users. The main control device in the star topology forms the central user of the network. In the chain topology, the main control device forms the first user. The secondary control devices are associated with the main control device according to the topology.

The sequence control preferably includes planned path movements of the at least two manipulators. The coordination effort may be reduced by integrating the planned path movements of the at least two manipulators into a sequence control that runs in the main control device, since it is not necessary to balance multiple sequence controls.

The objects of the invention are preferably further achieved by a manipulator system for the coordinated control of at least two manipulators, comprising at least two subordinate main control devices, wherein one of the at least two manipulators is associated with each main control device, and each main control device is configured for carrying out a sequence control of the manipulator that is associated with the main control device, wherein each of the main control devices includes a manipulator controller and an axis controller, and wherein the manipulator controller is configured for sending commands for controlling the axes of the manipulator associated with the main control device to the axis controller, and the axis controller is configured for converting commands for controlling the axes into converter commands, wherein the subordinate main control devices are spatially separate from one another, are set up in each case in their own housing, and in each case have an independent power supply, and comprising a coordination control device that is spatially separate from the subordinate main control devices, is set up in its own housing, and has an independent power supply, wherein the coordination control device is configured for coordinating the sequence controls of the at least two manipulators in such a way that the program sequence of the sequence controls takes place in a predetermined manner.

By using at least two subordinate main control devices in the manipulator system, it is possible to carry out the sequence control, including the planned path movement of the manipulator associated with the particular main control device, in this main control device.

The main control devices are preferably manipulator control devices that are preferably connected to the coordination control device via a bus connection. The manipulator controller of the particular main control device converts the sequence control into commands for controlling the axes of the manipulator, and sends these commands to the axis controller of the associated manipulator.

Coordinating the path movements of the at least two manipulators takes place in the separate coordination control device. As a result, when carrying out the planned path movement by means of the subordinate main control devices, no interference in carrying out the path movements, due to additional computing tasks such as coordination of the planned path movements of the at least two manipulators, is anticipated. In addition, coordinating the planned path movements of the at least two manipulators is possible with minimal exchange of signals, since only the signals that are necessary for the coordination need to be sent to or from the coordination control device.

Coordinating the path movements of the at least two manipulators by means of the separate coordination control device also allows direct intervention in the manipulator controllers of the manipulators in order to improve the interaction of the manipulators, and in particular to shorten cycle times. For example, if the second manipulator is not allowed to carry out an additional movement until a position condition of the first manipulator has been met, the speed of the first manipulator may be increased by intervening in the coordination control device in order to shorten the waiting time for the second manipulator. The coordination control device may thus influence the manipulator controllers of both manipulators in order to optimize the interaction of the manipulators. For this purpose, the coordination control device may access parameters such as the manipulator speed, the manipulator acceleration, or other manipulator parameters.

Using a coordination control device having subordinate main control devices also allows the simple expansion of the manipulator system with additional manipulators. Since the main control devices carry out the sequence control, including the planned path movement of the associated manipulator, the main control device, including the sequence control together with the manipulator, forms an independent unit. Thus, for coordinating multiple manipulators it is necessary only to adapt the coordination program that is carried out on the coordination control device. Simple expansion of the manipulator system is thus possible.

The spatial separation of the subordinate main control devices and the coordination control device also allows simple expansion of the manipulator system. Due to the independent power supplies of the main control devices and of the coordination control device, they may be situated in practically any spatial arrangement. In particular, they are situated in the immediate vicinity of the associated manipulators in order to reduce the length of the power-conducting lines and thus avoid line losses.

Each sequence control preferably includes planned path movements of the manipulator associated with the main control device of the sequence control. Due to providing separate sequence controls for the planned path movements of each manipulator, each subordinate main control device may control the manipulator as described. Thus, only the coordination of the planned path movements is relocated from the subordinate main control devices, and is ultimately carried out by the coordination control device.

Converters for controlling the actuators of the axes of the manipulator are preferably associated with each manipulator, wherein the converters are set up in the housing of the main control device and/or the secondary control device associated with the manipulator.

At least one manipulator of the manipulator system is preferably an industrial robot, and the at least second manipulator is set up on an axis of the industrial robot. When the second manipulator is set up on an axis of the industrial robot, in addition to the existing degrees of freedom, the industrial robot may be provided with additional degrees of freedom in the form of the axes of the second manipulator. In this way, complex movements that cannot be achieved with the degrees of freedom of the actual industrial robot may be realized, since the coordination of the industrial robot and of the additional axes, i.e., the second manipulator, may be easily achieved as described above.

Likewise, the second manipulator may be a tool which is mountable on the industrial robot and which has at least one controllable axis or one controllable actuator. The second manipulator may thus be positioned and/or oriented by the industrial robot.

The manipulator system is preferably configured in such a way that the coordination of the planned path movements of the manipulators is carried out by means of real-time synchronization. The real-time synchronization may take place via real time-capable bus connections or via a deterministic real-time interface. For this purpose, either the main computer is connected to the manipulator controllers, or the main control device is connected to the secondary control devices, or the subordinate main control devices and the coordination control device are connected via a deterministic real-time interface. It may thus be ensured that in the coordination of the planned path movements of the manipulators, the required computing results of the coordinated control are guaranteed to be present within a defined time interval. Control of the coordinated, planned path movements of the at least two manipulators is thus possible.

The axis controller of the manipulator system is preferably an intelligent axis controller, the intelligent axis controller including axis angle control of the individual axes of the manipulator and a higher-level Cartesian control. An intelligent axis controller is advantageous, since in the hierarchical system level of the axis controllers it is not necessary to control the axes of the manipulator individually and separately from one another. Rather, in the control of an individual axis it is also possible to take into account movements of the other axes, so that more complex movement sequences may be implemented, and greater path speeds and path accelerations may be achieved. This is particularly advantageous in industrial applications, since smaller cycle times may thus be achieved, as the result of which the manipulator system may operate more cost-efficiently.

At least one second manipulator may preferably be controlled regardless of a malfunction of a first manipulator, wherein the at least second manipulator behaves in accordance with the control. This is advantageous due to the fact that the manipulator system may continue operating even when one of the manipulators fails due to a malfunction. For example, if a malfunction is present in a manipulator controller, an axis controller, or a secondary control device, only the manipulator that is directly affected fails. The remaining manipulators of the manipulator system may continue to carry out their planned path movements.

### 4. DESCRIPTION OF THE FIGURES

FIGS. 1 through 3 described below show preferred embodiments of the invention, as follows:

FIG. 1 shows a manipulator system for the coordinated control of at least two manipulators, including a main computer;

FIG. 2 shows a manipulator system for the coordinated control of at least two manipulators, including a main control device and a secondary control device, and

FIG. 3 shows a manipulator system for the coordinated control of at least two manipulators, including two subordinate main control devices and a coordination control device.

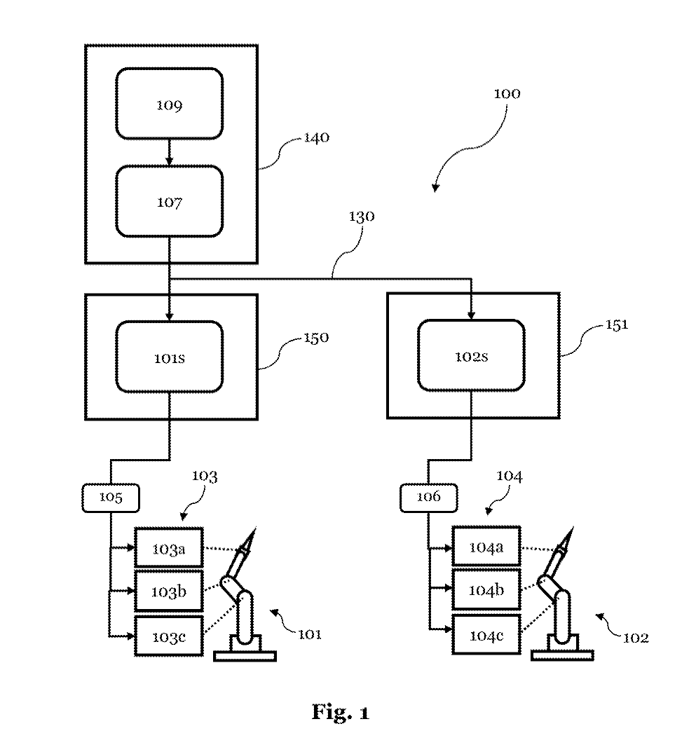

In particular, system components that are preferably designed as software are illustrated as rectangles with rounded corners in FIGS. 1 through 3. System components that are preferably designed as hardware are illustrated as rectangles with sharp corners.

FIG. 1 shows a manipulator system 100 whose design corresponds essentially to the manipulator system claimed in Claim 1. The manipulator system 100 is used for the coordinated control of at least two manipulators 101, 102. The manipulators 101, 102 shown are multiaxial manipulators having at least three axes. Such multiaxial manipulators 101, 102 usually have at least six axes. However, not all axes of the manipulators 101, 102 are shown on account of the schematic illustration of FIG. 1.

An actuator (not shown), which may be controlled by means of a converter 103a, 103b, 103c, 104a, 104b, 104c, is associated with each axis of a manipulator 101, 102. The number of converters used is not limited to the number of converters 103a, 103b, 103c, 104a, 104b, 104c illustrated; rather, one converter is typically associated with each actuator. The converter associated with an actuator is situated in the vicinity of the actuator in such a way that the converter can be moved along with a movement of the manipulator. The converters are typically situated on the manipulator arms, preferably in the manipulator arms. This arrangement is schematically illustrated by the dotted lines in FIG. 1. The converters 103a, 103b, 103c together form the converter assembly 103 of the manipulator 101, and the converters 104a, 104b, 104c together form the converter assembly 104 of the manipulator 102.

The illustrated manipulator system 100 includes a main computer 140 that is configured for carrying out a sequence control 109. The sequence control 109 includes planned path movements of the manipulators 101, 102 that have been planned by a user. A command switch 107 included in the main computer 140 is configured for sending commands of the sequence control to the manipulator controllers 101S, 102S of the manipulators 101, 102, and the manipulator controllers 101S, 102S are configured for converting the commands of the sequence control, including the planned path movements of the manipulators 101, 102, into commands for controlling the respective axes of the corresponding manipulators 101, 102.

The commands for controlling the axes are sent from the main computer 140 to manipulator controllers 101S, 102S via an Ethernet-based bus connection 130 and converted by the manipulator controllers 101S, 102S.

The manipulator controllers 101S, 102S then send commands for controlling the axes to the associated axis controllers 105, 106. The manipulator controllers 101S, 102S are set up in their own housings 150, 151, spatially separate from the main computer 140. The axis controllers 105, 106 typically include hardware and software, and are preferably situated in the vicinity of the associated manipulator, particularly preferably in such a way that the axis controllers 105, 106 (i.e., the hardware) can be moved along with a movement of the manipulator 101, 102. The axis controllers 105, 106 are configured for converting the commands for controlling the axes into converter commands.

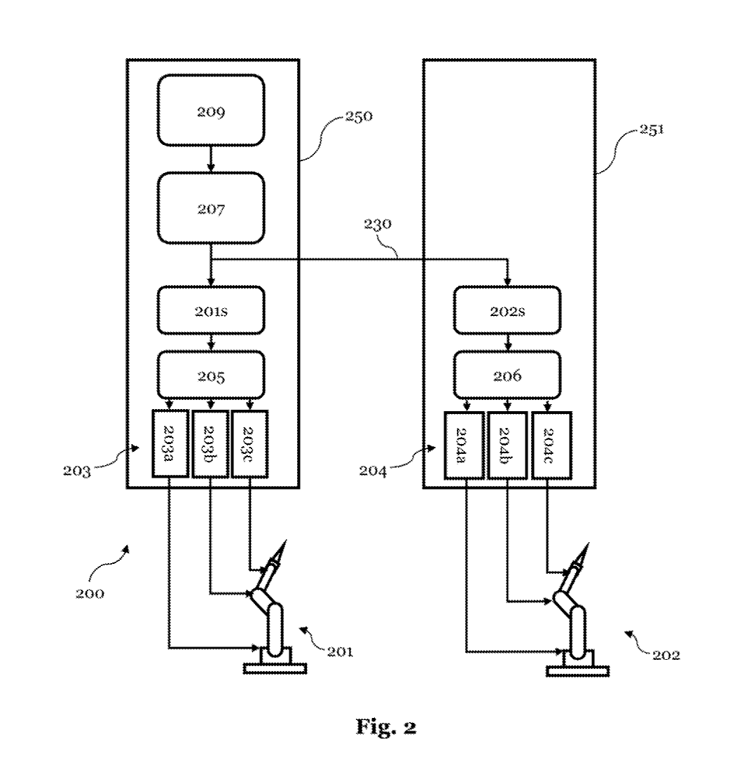

FIG. 2 shows a manipulator system 200 whose design corresponds essentially to the manipulator system claimed in Claim 7. The manipulator system 200 is used for the coordinated control of at least two manipulators 201, 202. The manipulators 201, 202 shown are multiaxial manipulators having at least three axes.

The illustrated manipulator system 200 includes a main control device 250 that is associated with the manipulator 201. In addition, the manipulator system 200 includes a secondary control device 251 that is associated with the manipulator 202. The main control device 250 includes a sequence control 209, a command switch 207, and a manipulator controller 201S as well as at least one axis controller 205, and is configured for carrying out the sequence control 209. The command switch 207 is configured for sending commands of the sequence control 209 to the manipulator controllers 201S and 202S. The manipulator controller 201S sends commands for controlling the axes of the manipulator 201 to the axis controller 205, and the manipulator controller 202S sends commands for controlling the axes of the second manipulator 202 to the associated axis controller 206.

The axis controller 205 converts the commands for controlling the axes into converter commands, which are sent to the converter assembly 203. The converter assembly 203 includes the converters 203a, 203b, 203c of the actuators of the axes of the manipulator 201. The number of converters used is not limited to the number of converters 203a, 203b, 203c illustrated. Rather, one converter is typically associated with each actuator of the manipulator. In this variant, the converters 203a, 203b, 203c, together with the axis controller 205, the manipulator controller 201S, and the command switch 207, are preferably situated in the housing of the main control device 250.

The secondary control device 251 is associated with the manipulator 202. In particular, the secondary control device 251 is spatially separate from the main control device 250 and is set up in its own housing. The secondary control device 251 preferably has an independent power supply (not shown). The main control device 250 and the secondary control device 251 may thus be situated in the immediate vicinity of their associated manipulators 201, 202, and the power-conducting lines from the main control device 250 and/or the secondary control device 251 to the manipulators 201, 202 may have a correspondingly short design. Line losses are avoided in this way.

The secondary control device 251 includes a manipulator controller 202S and an axis controller 206, wherein the command switch 207 of the main control device 250 sends commands of the sequence control 209 to the manipulator controller 202S. The manipulator controller 202S sends commands for controlling the axes of the manipulator 202 to the axis controller 206. The axis controller 206 converts the commands for controlling the axes into converter commands, which are sent to the converter assembly 204. The converter assembly 204 includes the converters 204a, 204b, 204c of the actuators of the axes of the manipulator 202. The converters 204a, 204b, 204c together with the manipulator controller 202S and the axis controller 206 are preferably situated in the housing of the secondary control device 251.

The secondary control device 251 is associated with the main control device 250 via an Ethernet-based bus connection 230. The coordination of the planned path movements of the manipulators 201, 202 takes place in the command switch 207. The commands of the sequence control 209 are transmitted from the command switch 207 to the manipulator controller 202S via the Ethernet-based bus connection 230.

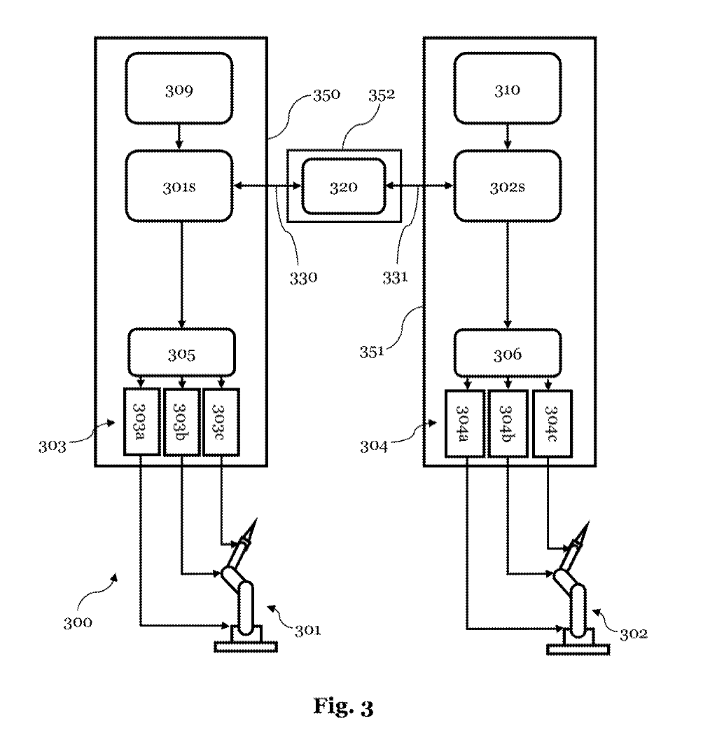

FIG. 3 shows a manipulator system 300 whose design corresponds essentially to the manipulator system claimed in Claim 10. The manipulator system 300 is used for the coordinated control of at least two manipulators 301, 302.

The illustrated manipulator system 300 includes two subordinate main control devices 350, 351, which are associated with one another by means of a coordination control device 320 via an Ethernet-based bus connection 330,331. The manipulator 301 is associated with the subordinate main control device 350, and the manipulator 302 is associated with the subordinate main control device 351. Each of the subordinate main control devices 350, 351 carries out a sequence control 309, 310 associated with the manipulators 301, 302.

The sequence control 309 includes planned path movements of the manipulator 301, and the sequence control 310 includes planned path movements of the manipulator 302. Each of the main control devices 351 includes its own manipulator controller 301S, 302S and its own axis controller 305, 306. The manipulator controllers 301S, 302S send commands for controlling the axes to the axis controllers 305, 306. The axis controllers 305, 306 convert the received commands for controlling the axes into converter commands, which are sent to the respective converter assemblies 303, 304. The converter assemblies 303, 304 include the converters 303a, 303b, 303c and the converters 304a, 304b, 304c, respectively, of the actuators of the manipulators 301, 302. The converters 303a, 303b, 303c and 304a, 304b, 304c together with the axis controllers 305, 306 are preferably situated in the respective housing of the subordinate main control devices 350, 351.

The subordinate main control devices 350, 351 are spatially separate from one another, preferably in the immediate vicinity of their associated manipulators 301, 302, are set up in each case in their own housing, and have an independent power supply (not illustrated). The subordinate main control devices 350, 351 and in particular the manipulator controllers 301S, 302S carry out the sequence controls 309, 310 of the manipulators 301, 302. Thus, an independent manipulator control device (main control device) is available for each of the manipulators 301, 302.

For coordinating the planned path movements of the manipulators 301, 302, the subordinate main control devices 350, 351 are connected to one another by means of a coordination control device 320 via an Ethernet-based bus connection 330, 331. The coordination control device 320 is also situated in its own housing 352, spatially separate from the subordinate main control devices 350, 351, and has an independent power supply (not shown). The coordination control device 320 coordinates the manipulators 301, 302 in such a way that the program sequence of the sequence controls 309, 310 takes place in a certain way.

This may be based on a previously determined time sequence, or on movement conditions of the manipulator movements, as described above. Likewise, the coordination control device 320 may intervene in the sequence controls 309, 310 as described above.

All manipulator systems 100, 200, 300 shown share the common feature that, due to the described arrangement of the individual components of the manipulator systems 100; 200; 300, it is possible to easily expand the manipulator systems with additional manipulators (not shown). The additional manipulators are incorporated into the existing manipulator system, and are preferably based on a star topology or based on a chain topology. In addition, arranging the components in independent housings allows any desired spatial arrangement of the components, and thus, a reduction in the required length of the power-conducting lines. This results in a robust manipulator that is less susceptible to malfunctions, and that has lower line losses.

### LIST OF REFERENCE NUMERALS

100; 200; 300 . . . manipulator systems
101, 102; 201, 202; 301, 302 . . . multiaxial manipulators
103, 104; 203, 204; 303, 304 . . . converter assemblies
103a-c, 104a-c; 203a-c, 204a-c;
303a-c, 304a-c... converters
105, 106; 205, 206; 305, 306 . . . axis controllers
107; 207; . . . command switches
101s; 102s; 201s; 222s;
301s; 302s. . . manipulator controllers
109; 209; 309, 310 . . . sequence controls
130; 230; 330, 331 . . . Ethernet-based bus connections
140 . . . main computer
150, 151 . . . housing of the manipulator
controllers 101S, 102S
250 . . . main control device
251 . . . secondary control device
320 . . . coordination control device
352 . . . housing of the coordination control device
350, 351 . . . subordinate main control devices

1. A manipulator system for the coordinated control of at least two manipulators, comprising:
a main computer that is configured for carrying out a sequence control,
at least two multiaxial manipulators, and
at least two manipulator controllers,
wherein each one of the at least two manipulator controllers is associated with one of the at least two manipulators, the manipulator controllers each being spatially separate from the main computer and in its own housing, and wherein
each multiaxial manipulator includes a plurality of converters for controlling actuators associated with each of a plurality axes of the multiaxial manipulator, wherein
the converter associated with each actuator is situated in the vicinity of the actuator in such a way that the converter can be moved along with a movement of the manipulator.

2. The manipulator system according to claim 1, wherein the converter associated with each actuator is situated in a manipulator arm.

3. The manipulator system according to claim 1, further comprising:
at least two axis controllers,
wherein at least one of the at least two axis controllers is associated with each manipulator, and the at least one axis controller is positioned on the particular manipulator in such a way that the at least one axis controller can be moved along with a movement of the manipulator.

4. The manipulator system according to claim 3, wherein the at least two axis controllers are associated with the main computer in a chain topology or in a star topology.

5. The manipulator system according to claim 1, wherein the main computer comprises:
a a sequence control unit that includes planned path movements of the at least two manipulators, and
a command switch that is configured for coordinating planned path movements of the at least two manipulators.

6. The manipulator system according to claim 5, further comprising:
at least two axis controllers, wherein:
the main computer is configured for sending commands of the sequence control unit to the manipulator controllers associated with each of the manipulators,
at least one of the at least two axis controllers is associated with each manipulator,
each manipulator controller is configured for sending commands to the at least one axis controller associated with its respective manipulator for controlling the axes of the manipulator, and
the axis controllers are configured for converting commands received from the manipulator controllers for controlling the axes into converter commands to be executed by the converters.

7. A manipulator system for the coordinated control of at least two manipulators, comprising:
a main control device that is associated with a first one of the at least two manipulators and that includes a sequence control unit configured for carrying out a sequence control, wherein:
the main control device includes a command switch, a first manipulator controller, and a first axis controller, wherein the command switch is configured for sending commands of the sequence control unit to a first manipulator controller, and
the first manipulator controller is configured for sending commands for controlling axes of the first manipulator to a first axis controller, and the first axis controller is configured for converting commands for controlling the axes into commands to be executed by converters for controlling actuators associated with the axes of the first manipulator, and
at least one secondary control device which is associated with the second of the at least two manipulators, wherein:
the least one secondary control device is spatially separate from the main control device, is set up in its own housing, and has an independent power supply, wherein
the at least one secondary control device includes a second manipulator controller, and
the command switch of the main control device is configured for sending commands of the sequence control unit to the second manipulator controller, and the second manipulator controller is configured for sending commands for controlling axes of the second manipulator to a second axis controller of the second manipulator, and the second axis controller is configured for converting commands for controlling the axes into commands to be executed by converters for controlling actuators associated with axes of the second manipulator.

8. The manipulator according to claim 7, wherein the manipulator system includes a third manipulator having a third secondary control device, and the secondary control devices are associated with the main control device in a chain topology or in a star topology.

9. The manipulator system according to claim 7, wherein the sequence control unit includes planned path movements of the at least two manipulators.

10. A manipulator system for the coordinated control of at least two manipulators, comprising
at least two subordinate main control devices, wherein:
one of the at least two manipulators is associated with each main control device, and each main control device is configured for carrying out a sequence control of the manipulator that is associated with the main control device,
each of the main control devices includes a manipulator controller and an axis controller,
the manipulator controllers are each configured for sending commands for controlling axes of the manipulator associated with a respective one of the main control devices to the axis controller of the one main control device, and the axis controller is configured for converting commands for controlling the axes into commands to be executed by converters for controlling actuators associated with axes of the manipulator, and
the subordinate main control devices are spatially separate from one another, are set up in each case in their own housing, and in each case have an independent power supply, and
a coordination control device that is spatially separate from the subordinate main control devices, is set up in its own housing, and has an independent power supply, wherein the coordination control device is configured for coordinating the sequence control of the at least two manipulators in such a way that a program sequence of the sequence controls takes place in a predetermined manner.

11. The manipulator system according to claim 10, wherein the subordinate main control devices of the coordination control device are associated in a chain topology or in a star topology.

12. The manipulator system according to claim 10, wherein a sequence control unit for each main control device includes planned path movements of the manipulator, which is associated with the main control device.

13. The manipulator system according to claim 7, wherein converters for controlling the actuators associated with the axes of the manipulators are associated with each manipulator, and the converters associated with each manipulator are set up in the housing of the main control device or secondary control device that is associated with the manipulator.

14. The manipulator system according to claim 7, wherein each manipulator includes converters for controlling the actuators associated with the axes of the manipulator, and each converter associated with one of the actuators is set up in the vicinity of the actuator in such a way that the converter can be moved along with a movement of the manipulator.

15. The manipulator system according to claim 14, wherein at least one of a plurality of axis controllers is associated with each manipulator, and the at least one axis controller is situated on the manipulator in such a way that the at least one axis controller can be moved along with a movement of the manipulator.

16. The manipulator system according to claim 1, wherein at least one of the at least two manipulators is an industrial robot, and a second one of the at least two manipulators is set up on an axis of the industrial robot.

17. The manipulator system according to claim 5, wherein the manipulator system is configured in such a way that the coordination of the planned path movements of the manipulators takes place via an Ethernet-based bus connection.

18. The manipulator system according to claim 5, wherein the manipulator system is configured in such a way that the coordination of the planned path movements of the manipulators is carried out by means of real-time synchronization.

19. The manipulator system according to claim 1, wherein at least one of the axis controllers is an intelligent axis controller, and the intelligent axis controller includes axis angle control of the individual axes of the manipulator and a higher-level Cartesian control.

20. The manipulator system according to claim 1, wherein at least a second one of the at least two manipulators may be controlled regardless of a malfunction of a first one of the manipulators, and behaves in accordance with the sequence control.
